(19) United States
(12) Patent Application Publication
(10) Pub. No.: US 2010/0261036 A1
(43) Pub. Date: Oct. 14, 2010

(54) Light-Reflective Articles

(75) Inventors: Frank Calcagni, Austin, TX (US); Jeanne D. Housman, Chestnut Hill, MA (US)

Correspondence Address: JAY M BROWN, 6409 FAYETTEVILLE RD. SUITE 120-306, DURHAM, NC, 27713, US

(73) Assignee: VTEC TECHNOLOGIES, LLC, Southfield, MI (US)

(21) Appl. No.: 12/422,245

(22) Filed: Apr. 10, 2009

(51) Int. Cl. B32B 15/08; B05D 5/06

(52) U.S. Cl. 428/626; 427/164

(57) ABSTRACT

Article that includes optically-transmissive metal layer on light-reflective metal layer. Optically-transmissive metal layer has composition including at least about ten molar % of chromium. Article further includes optically-transmissive metal-adhering layer on optically-transmissive metal layer. Optically-transmissive metal-adhering layer has composition including metal oxide. Article also includes optically-transmissive protective layer on optically-transmissive metal-adhering layer. Optically-transmissive protective layer has composition including organic moiety-containing polymer. Method that includes providing light-reflective metal layer. Method also includes forming optically-transmissive metal layer on light-reflective metal layer wherein optically-transmissive metal layer has composition including at least about ten molar % chromium. Method further includes forming optically-transmissive metal-adhering layer on optically-transmissive metal layer wherein optically-transmissive metal-adhering layer has composition including metal oxide. Method additionally includes forming optically-transmissive protective layer, having composition including organic moiety-containing polymer, on optically-transmissive metal-adhering layer.

### BACKGROUND

1. Field of the Invention

This invention generally relates to light-reflective articles.

2. Related Art

Various types of light-reflective articles have been developed for use as mirrors or optical lenses and in other devices where a reflective or shiny appearance is functionally or aesthetically useful. Such light-reflective articles typically include a system of layers, including a light-reflective layer. The light-reflective layer in some of these articles has been a metal layer. In addition, some of these articles have been supported on a substrate. Substrates having an organic polymer composition have been used.

There is a continuing need for light-reflective articles including a light-reflective metal layer, particularly such light-reflective articles exhibiting excellent hardness, abrasion resistance, and other performance criteria related to light reflection and article durability.

### SUMMARY

In an example of an implementation, an article is provided that includes a light-reflective metal layer. The article has an optically-transmissive metal layer on the light-reflective metal layer, the optically-transmissive metal layer having a composition including at least about ten (10) molar percent (%) of chromium. The article also has an optically-transmissive metal-adhering layer on the optically-transmissive metal layer, the optically-transmissive metal-adhering layer having a composition including a metal oxide. The article further includes an optically-transmissive protective layer on the optically-transmissive metal-adhering layer, the optically-transmissive protective layer having a composition including an organic moiety-containing polymer.

As another example of an implementation, a method is provided. The method includes providing a light-reflective metal layer, and forming an optically-transmissive metal layer on the light-reflective metal layer, wherein the optically-transmissive metal layer has a composition including at least about ten (10) molar percent (%) of chromium. The method also includes forming an optically-transmissive metal-adhering layer on the optically-transmissive metal layer, wherein the optically-transmissive metal-adhering layer has a composition including a metal oxide. The method further includes forming an optically-transmissive protective layer on the optically-transmissive metal-adhering layer, the optically-transmissive protective layer having a composition including an organic moiety-containing polymer.

Other articles, methods, features and advantages of the invention will be or will become apparent to one with skill in the art upon examination of the following figures and detailed description. It is intended that all such additional articles, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a cross-sectional perspective view illustrating an example of an implementation of a light-reflective article.

FIG. 2 is a flow diagram illustrating an example of an implementation of a method.

### DETAILED DESCRIPTION

Various articles having a metal light-reflective layer are in widespread use. Depending on the nature of the finished light-reflective article, for example an automotive mirror or a decoratively shiny component of an automobile, the light-reflective article may be required to meet various structural specifications or other performance standards to be considered acceptable for commercial or industrial applications, one example being end-uses in the automotive industry.

Some light-reflective articles have been fabricated by solution-based electroplating or electroless plating. Some of these electroplated and electrolessly-plated articles have effectively met required structural specifications and other performance standards, but the fabrication techniques utilized in making these light-reflective articles have been accompanied by significant environmental and health-related problems. Electroplating and electroless plating typically entail the use of toxic plating solutions that include heavy metal compounds such as lead compounds and hexavalent chromium compounds. Lead is recognized as a neurotoxin, and hexavalent chromium is recognized as a human carcinogen. Such toxic plating solutions are therefore a serious hazard to the health of workers during fabrication of light-reflective articles, and also pose significant environmental waste disposal hazards. Restrictions on the utilization of solution-based electroplating and electroless plating in manufacturing processes continue to become more stringent, and solution-based metal plating techniques such as electroplating and electroless plating may ultimately be banned.

As an alternative to fabricating light-reflective articles by utilizing metal solution-based fabrication techniques such as electroplating and electroless plating, light-reflective articles including a metal light-reflective layer may also be fabricated by vapor deposition techniques, where for example the metal light-reflective layer is then coated with an optically-transmissive protective layer. However, the adhesion of such coatings to a metal light-reflective layer has sometimes been poor, resulting in failure modes such as defective or wholly unsuccessful coating coverage, cracking, and delamination. Additionally, performance properties of these coated light-reflective articles, such as abrasion resistance and hardness, are still often considered unacceptable for many applications. Attempts to deposit a coating for protective purposes on a metal light-reflective layer having a significant molar content of chromium, for example, have not resulted in light-reflective articles that meet the various structural specifications and other performance standards required by many industries. Well-known problems resulting from attempts to fabricate light-reflective articles having a chromium-containing light-reflective layer and having an optically-transmissive protective coating have included, as examples, unsuccessful and defective coating surface coverage, poor coating adhesion, and poor structural integrity of the light-reflective articles. As an example, protective coatings including an organic polymer generally do not effectively adhere onto chromium-containing light-reflective layer surfaces. Moreover, commercial acceptability of light-reflective articles including a chromium-containing light-reflective layer surface and including an optically-transmissive protective coating would further entail satisfying practical requirements for such light-reflective articles to resist abrasion and scratching, to demonstrate adequate reflective surface hardness, and to effectively perform in end-use environmental and durability testing such as thermal cycling, moisture cycling, salt-spray corrosion resistance cycling, and other such testing.

An article is provided herein that includes a light-reflective metal layer, an optically-transmissive metal layer on the light-reflective metal layer, an optically-transmissive metal-adhering layer on the optically-transmissive metal layer, and an optically-transmissive protective layer on the optically-transmissive metal-adhering layer. The optically-transmissive metal layer has a composition including at least about ten (10) molar percent (%) of chromium. The optically-transmissive metal-adhering layer has a composition including a metal oxide. The optically-transmissive protective layer has a composition including an organic moiety-containing polymer. The metal oxide in the composition of the optically-transmissive metal-adhering layer may, for example, include silicon. The organic moiety-containing polymer in the optically-transmissive protective layer may, for example, include silicon. The article may have a covalent bonding interface between the optically-transmissive protective layer and the optically-transmissive metal-adhering layer. For example, the organic moiety-containing polymer in the optically-transmissive protective layer may have a composition including a metal M₁, the metal oxide in the composition of the optically-transmissive metal-adhering layer may include a metal M₂, and the bonding interface may have a plurality of covalent M₁-oxygen-M₂ bonds. As an example, these covalent bonds may include silicon-oxygen-silicon bonds.

The following conventions apply regarding terminology utilized throughout this specification. A “layer” of a material is any component of a light-reflective article that is bonded or attached to, formed or deposited on, or otherwise provided on any other component of the light-reflective article. A layer may include, as examples, a surface, film, foil, region, body, or substrate. When a layer is referred to as being “on” or “over” another layer, then all or a portion of the layer may be directly on and in contact with all or a portion of the other layer, or alternatively, intervening layers may also be present such that all or portions of the one layer and another layer “on” or “over” the one layer are not mutually in direct contact. When a layer is stated as being “directly on” another layer, then no intervening layer is present unless otherwise indicated. When a layer is stated as being “between” two other layers, then one or more additional intervening layers may also be present between the two other layers. When a layer is referred to as being “on” (or “over”) another layer, then the layer may cover the entire surface of the other layer, or may cover only a portion of the other layer. Terms such as “formed on”, “disposed on”, or “deposited on” are not intended to introduce any limitations relating to specific methods for fabricating a layer except as otherwise designated.

The following additional conventions apply regarding terminology utilized throughout this specification. The term “light-reflective” indicates that a given article or layer reflects between about forty percent and about one hundred percent (40-100%) of the visible light incident on the article or layer as measured by SAE J964 (February 2003) and ASTM E429 (1991), the entireties of which standards are incorporated by reference herein. The term “optically-transmissive” means that a given layer of a light-reflective article transmits a light image entering into and passing through the layer, then reflected from a light-reflective surface and passed back through the layer. An “optically-transmissive” layer herein may, for example, transmit visible light having selected wavelength ranges and thereby alter the perceptual color of the transmitted light. A surface of a light-reflective article is deemed to be “optically smooth” if the surface satisfies the Rayleigh criterion, so that d<λ(8 cos θ), where d is the surface roughness (root-mean-square roughness height), λ is the wavelength of the incident illumination (spanning the visible light spectrum), and θ is the angle of incidence of this illumination, where θ is within a range of between about 20 degrees and about 60 degrees from the direction normal to the surface plane. The visible light spectrum spans the wavelength range within a range of between about 400 nanometers (“nm”) and about 750 nm. Light having wavelengths within a range of between about 400 nm and about 485 nm is perceived as blue. Light having wavelengths within a range of between about 485 nm and about 585 nm is perceived as green. Light having wavelengths within a range of between about 585 nm and about 750 nm is perceived as red. A light-reflective article may be tested for optical smoothness by utilizing ASTM D-2457-03 “Standard Test Method for Specular Gloss of Plastic Films and Solid Plastics” (2007), the entirety of which is incorporated by reference into this specification. Reflectance may be defined as the average fraction of incident solar light within the visible wavelength range that is reflected by a surface. Reflectance may be determined by utilizing spectrophotometric measurements at multiple wavelengths. The average optical reflectance may then be determined by an averaging process, using a standard solar light spectrum. The testing procedure disclosed in SAE J964 “Recommended Practice for Measuring Haze and Reflectance of Mirrors” (1998), the entirety of which is incorporated by reference into this specification, may be utilized. Certain end-use applications for light-reflective articles may be useful for reflecting light partially or wholly outside the visible wavelength range. In such cases, a suitable wavelength range for operation of the light-reflective article in such end-use applications may be substituted for the visible wavelength range, and average reflectance may be determined in an analogous manner.

Additional conventions that apply regarding terminology utilized throughout this specification include the following. The term “organic” denotes a chemical composition having a hydrocarbon moiety including at least one carbon-hydrogen bond, and which may include one or more additional elements such as oxygen, metals and halogens. The term “organic moiety” denotes a branched, linear, or branched and linear, substituted or unsubstituted or partially-substituted, hydrocarbon moiety including at least one carbon-hydrogen bond. The term “organic moiety-containing polymer” denotes a polymeric composition having a moiety including a branched, linear, or branched and linear, substituted or unsubstituted or partially-substituted, hydrocarbon chain of any variable or uniform length, and which may have other portions, which may include inorganic moieties. Designation of a moiety in a polymerized composition as corresponding to a particular monomer likewise designates a reaction product resulting from polymerization of that monomer in forming the polymerized composition. Designations of a monomer also include oligomers, pre-polymers and the like having chemical structures that correspond to and that result from polymerization reactions involving such monomers. Designations of a polymer also include co-polymers, and polymers having an interpenetrating polymer network. Designation of a monomer or polymer includes corresponding substituted monomers or polymers having substituents including, as examples, substituents selected from halogens, hydroxyl groups, and alkyl, alkenyl and alkynyl moieties. The terms alkyl, alkenyl and alkynyl include, as non-limiting examples, moieties having 1-20 carbon atoms. Halogens include chlorine, bromine, iodine and fluorine, as examples. The terms “aryl”, “phenyl” and “benzyl” are synonymous and designate one or more phenyl groups, which may be conjugated, un-conjugated, fused, or otherwise bonded, and may or may not be substituted. As non-limiting examples, a “phenyl” group may include between one and five benzene rings. The term “unsaturated” means that the subject monomer or polymer includes one or more pairs of two carbon atoms sharing a double or triple covalent bond. Ethylenically unsaturated monomers may be suitable, as an example, for free-radical polymerization in forming polymers. Free-radical polymerization may be initiated and catalyzed, as an example, by ultraviolet light-induced activation of an initiator. Such ethylenically unsaturated monomers may include, for example, a monomer having a carbonyl group including an alpha-beta-ethylenically unsaturated moiety, such as a vinyl group, susceptible to free-radical polymerization.

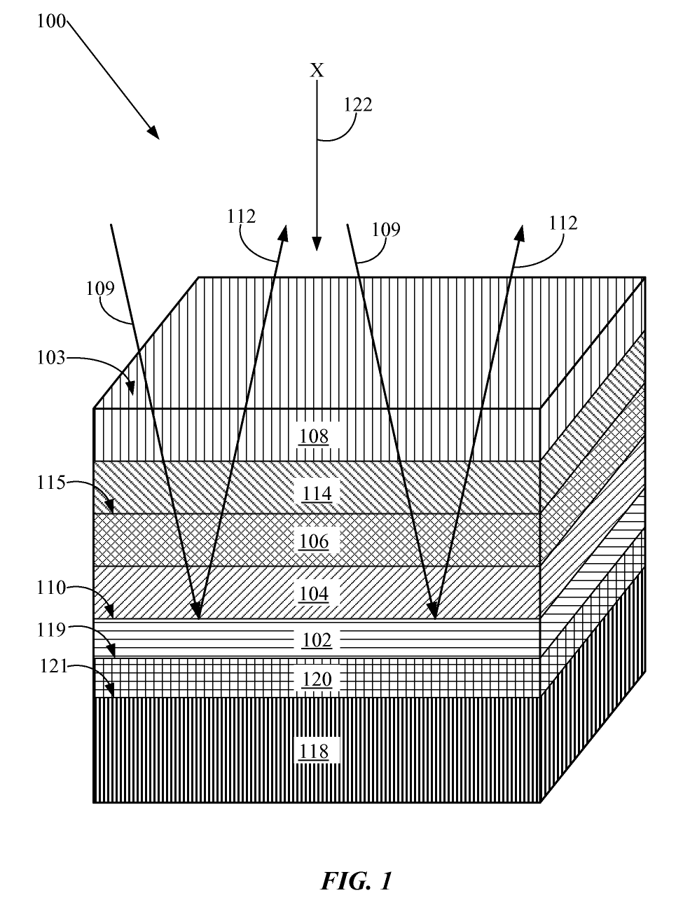

FIG. 1 is a cross-sectional perspective view illustrating an example of an implementation of a light-reflective article 100. The article 100 includes a light-reflective metal layer 102, an optically-transmissive metal layer 104, an optically-transmissive metal-adhering layer 106, and an optically-transmissive protective layer 108. The optically-transmissive metal layer 104 is on the light-reflective metal layer 102; the optically-transmissive metal-adhering layer 106 is on the optically-transmissive metal layer 104; and the optically-transmissive protective layer 108 is on the optically-transmissive metal-adhering layer 106. The optically-transmissive metal layer 104 has a composition including at least about ten (10) molar percent (%) of chromium. The optically-transmissive metal-adhering layer 106 has a composition including a metal oxide. The optically-transmissive protective layer 108 has a composition including an organic moiety-containing polymer.

The optically-transmissive protective layer 108 is capable of receiving light for reflection by the light-reflective metal layer 102. For example, incident light traveling in directions generally depicted by arrows 109 may enter the light-reflective article at an exterior surface 103, pass through the optically-transmissive protective layer 108, the optically-transmissive metal-adhering layer 106, and the optically-transmissive metal layer 104, may then be reflected by a surface 110 of the light-reflective metal layer 102, and subsequently travel back through the optically-transmissive metal layer 104, the optically-transmissive metal-adhering layer 106 and the optically-transmissive protective layer 108, exit from the light-reflective article 100 at the exterior surface 103, and travel away from the light-reflective article 100 in directions generally depicted by arrows 1 12. The surface 110 of the light-reflective metal layer 102 may serve as the primary visible light reflector of the light-reflective article 100. The light-reflective surface 110 may be, as an example, characterized as being optically smooth. The light-reflective article 100 may be characterized as being a front-surface light-reflective article 100.

The light-reflective metal layer 102 may as examples have a composition including aluminum, silver, gold, titanium, platinum, palladium, tin, zinc, nickel, molybdenum, or a combination including two or more of the foregoing. As another example, the light-reflective metal layer 102 may have a composition including one or a plurality of the foregoing metal elements, the composition further being selected such that the light-reflective metal layer 102 has an average optical reflectance of light across the visible light spectrum of at least about 80% where the light-reflective metal layer 102 is sufficiently thick for negligible transmission of visible light through the light-reflective metal layer 102. Further, for example, a light-reflective metal layer 102 having a composition including aluminum may have an average optical reflectance of light across the visible light spectrum within a range of between about 80% and about 90%.

The optically-transmissive metal layer 104 has a composition including at least about ten (10) molar percent (%) of chromium. As an example, the optically-transmissive metal layer 104 may have a composition including stainless steel. It is understood throughout this specification that the term “stainless steel” denotes an iron-carbon-containing alloy also including at least ten and a half molar percent (10.5%) of chromium. As another example, the optically-transmissive metal layer 104 may have a composition including at least about ten (10) molar % of chromium, together with one or a plurality of additional elements. Further, for example, the optically-transmissive metal layer 104 may have a composition including at least about fifty (50) molar % of chromium together with one or a plurality of additional elements. In another example, the optically-transmissive metal layer 104 may have a composition including at least about 99 molar percent of chromium.

In an example of a light-reflective article 100, the light-reflective metal layer 102 may have a composition selected for high reflectivity of light at wavelengths over the visible light spectrum, including light perceived as blue at wavelengths within a range of between about 400 nm and about 485 nm; light perceived as green at wavelengths within a range of between about 485 nm and about 585 nm; and light perceived as red at wavelengths within a range of between about 585 nm and about 750 nm. Further in that example, the optically-transmissive metal layer 104 may have a composition and physical thickness determined so as to selectively transmit and absorb light at various wavelength ranges over the visible light spectrum. As an example, the optically-transmissive metal layer 104 may function as a selective light transmitter and absorber, serving to moderate the spectral performance of the light-reflective article 100 by changing the relative intensities of light passing out of the light-reflective article 100 in directions of arrows 112 within wavelength ranges perceived as blue, green and red or within portions of such wavelength ranges. Changing these relative intensities of light may serve to balance or reduce perceived intensities of light reflected by the light-reflective article 100 having various wavelengths, or may serve to selectively imbalance such perceived intensities, and may aesthetically change the perceptual color of the light-reflective article 100 itself.

For example, a composition of the optically-transmissive metal layer 104 including at least about ten (10) molar % of chromium may be modified to control the visible light absorbance of that composition at particular wavelength ranges within the visible light spectrum. The light absorbance of the optically-transmissive metal layer 104 across the visible light spectrum may be so modified by including one or more selected metal or metal oxide additives in the composition of the optically-transmissive metal layer 104. Examples of metals that may be added to the chromium in the composition include iron, molybdenum, rhenium, tin, rhodium, indium, bismuth, barium, titanium, tantalum, niobium, copper, cerium, lanthanum, zirconium, zinc, magnesium, and nickel. Examples of metal oxides that may be added to the chromium in the composition include oxides of tungsten, molybdenum, niobium, vanadium, and titanium. Further, a physical thickness of the optically-transmissive metal layer 104 may be selected so that more or less light absorbance occurs as light passes through the optically-transmissive metal layer 104 in directions of the arrows 109, 112. In this manner, the composition and physical thickness of the optically-transmissive metal layer 104 may be selected in order to define a profile of intensities of light reflection by the light-reflective article 100 over the visible light spectrum, and to define a perceptual color of the light-reflective article 100.

As an example, the optically-transmissive metal layer 104 may have a composition including at least about ten (10) molar % of chromium, together with one or a plurality of additional elements. For example, the optically-transmissive metal layer 104 may have a stainless steel composition. In further examples, the composition and physical thickness of the optically-transmissive metal layer 104 may be selected to adjust the perceptual color of light reflected by the surface 110 of the light-reflective metal layer 102 to a selected perceptual color. For example, a selected perceptual color may be defined by color space (x,y) coordinates under the 1931 Commission Internationale d'Eclairage (“CIE”) standard, utilizing an illuminant B light source at within plus or minus two (2) degrees of normal to the surface 110. Further, as examples, the perceptual color of light reflected by the surface 110 of the light-reflective metal layer 102 may be so adjusted to a portion of the CIE color space coordinates in which x is within a range of between about 0.32 and about 0.36; and in which y is within a range of between about 0.33 and about 0.39. This portion of the CIE color space may be a diamond-shaped region of the CIE color space defined by four (x,y) coordinate pairs including about: (0.32, 0.33), (0.34, 0.39), (0.38, 0.39) and (0.36, 0.33); the region centered at a point having coordinates of about (0.35, 0.35). The center point for this region of the CIE color space may also be expressed, for example, as having (x,y,z) coordinates of about (0.3333, 0.3487, 0.3181) within incident angles ranging between about 0° and about 30° for an illuminant color temperature of 5500 K simulating daylight. A light-reflective article 100 having such a perceptual color may aesthetically resemble a chrome reflective surface, even though either or both of the light-reflective metal layer 102 and the optically-transmissive metal layer 104 may have a composition including other metals and metal oxides. As an additional example, the CIE color space x value may be about 0.3001 and the CIE color space y value may be about 0.299997.

The metal oxide in the composition of the optically-transmissive metal-adhering layer 106 may include as examples one or more oxides of silicon, zirconium, titanium, aluminum, zinc, nickel, tungsten, tin, molybdenum, vanadium, magnesium, niobium, tantalum, cerium, hafnium, or a combination including two or more of the foregoing. For example, the metal oxide in the composition of the optically-transmissive metal-adhering layer 106 may include silicon. The silicon oxides may include SiₓO_{y} where x is about 1 and y is between about 1 and about 4, as examples including one or more of SiO, SiO₂, and SiO₄. Further in that example the composition of the optically-transmissive metal-adhering layer 106 may include one or a plurality of such silicon oxides at a combined concentration of about 99 molar percent or more of the composition. As an example, a composition including one or a plurality of such silicon oxides at a combined concentration of about 99.995 molar percent or more of the composition may be utilized. In another example, the metal oxide in the composition of the optically-transmissive metal-adhering layer 106 may be selected as suitable so that the optically-transmissive metal-adhering layer 106 may function as a protective layer of the light-reflective article 100 in addition to the optically-transmissive protective layer 108.

The organic moiety-containing polymer in the optically-transmissive protective layer 108 may be selected as corresponding to a curable, polymerizable composition including moieties capable of reaction with metal-bound oxygen atoms in a metal oxide of the optically-transmissive metal-adhering layer 106. As an example, the organic moiety-containing polymer in the optically-transmissive protective layer 108 may be selected as corresponding to a curable, polymerizable composition having silicon-containing moieties capable of reaction with metal-bound oxygen atoms in a metal oxide of the optically-transmissive metal-adhering layer 106. For example, a curable, polymerizable composition may be utilized having silicon-containing moieties that are in the form of, or that are capable of dissociation under polymerization conditions into, labile (-silicon-oxygen-hydrogen) moieties. Such labile (-silicon-oxygen-hydrogen) moieties in the polymerizable composition may then form coordinated hydrogen bonds paired with labile (-silicon-oxygen-hydrogen) moieties in the optically-transmissive metal-adhering layer 106 at a surface 115. Curing of the polymerizable composition may then include reaction between coordinated pairs of labile (-silicon-oxygen-hydrogen) moieties with release of water molecules and formation of covalent (-silicon-oxygen-silicon-) bonds.

The selected organic moiety-containing polymer in the optically-transmissive protective layer 108 may be a silicone corresponding to a curable, polymerizable composition having moieties including silicon, carbon, hydrogen and oxygen. Silicones are mixed inorganic-organic polymers, which may be formed on the optically-transmissive metal-adhering layer 106 by causing such a curable, polymerizable composition to polymerize while reacting with metal-bound oxygen atoms in the optically-transmissive metal-adhering layer 106. In that example, the light-reflective article 100 may include a covalent bonding interface between the optically-transmissive protective layer 108 and the optically-transmissive metal-adhering layer 106. The organic moiety-containing polymer in the optically-transmissive protective layer 108 may have a composition including a metal M₁, wherein a metal oxide in the composition of the optically-transmissive metal-adhering layer 106 includes a metal M₂, and wherein the bonding interface has a plurality of covalent (-M₁-oxygen-M₂-) bonds. For example, where each of M₁ and M₂ includes silicon, the bonding interface may have a plurality of covalent (-silicon-oxygen-silicon-) bonds. As an example, the organic moiety-containing polymer in the optically-transmissive protective layer 108 may be selected as corresponding to a curable, polymerizable sol-gel composition having silicon-containing moieties. Examples of commercially-available compositions that may be utilized in forming the optically-transmissive protective layer 108 include: silicone hardcoat compositions from Fosta-Tek Optics, 320 Hamilton Street, Leominster, Mass. 01453; Scratchguard coatings from OMS Optochemicals, 97 Columbus, Pointe Claire, Quebec, Canada, H9R 4K3; S-28-46 from Exxene Corporation, 5939 Holly Road, Corpus Christi, Tex. 78414; silicone resin grades AS4000, AS4700F, and PHC587 from Momentive Performance Materials, 22 Corporate Woods Boulevard, Albany, N.Y. 12211 USA; Solgard silicone hardcoat from Nippon Dacro Shamrock Co., LTD., 296 Shimokurata-cho, Totsuka-ku, Yokohama-shi, Kanagawa 244-0815, Japan; and Permanew siloxane sol-gels from California Hardcoating Co., 3517 Main St., Ste. 303, Chula Vista, Calif. 91911 USA. In further examples, titanium-containing polymerizable compositions, having chemical structures analogous to the foregoing silicon-containing compositions, may also be utilized.

The light-reflective article 100 may include an optically-transmissive metal oxide-adhering layer 114 having an organic moiety-containing composition, between the optically-transmissive metal-adhering layer 106 and the optically-transmissive protective layer 108. The organic moiety-containing composition of the optically-transmissive metal oxide-adhering layer 114 may include silicon. For example, the composition of the optically-transmissive metal oxide-adhering layer 114 may include one or a plurality of silanols selected as suitable for reaction with metal-bound oxygen atoms in the optically-transmissive metal-adhering layer 106, and suitable for reaction with metal-bound oxygen atoms that may be included in the optically-transmissive protective layer 108. In that example, the light-reflective article 100 may include a first covalent bonding interface between the optically-transmissive protective layer 108 and the optically-transmissive metal oxide-adhering layer 114, and a second covalent bonding interface between the optically-transmissive metal oxide-adhering layer 114 and the optically-transmissive metal-adhering layer 106. The organic moiety-containing polymer in the optically-transmissive protective layer 108 may have a composition including reactive oxygen atoms bound to a metal M₁, the metal oxide in the composition of the optically-transmissive metal-adhering layer 106 may include a metal M₂, and the composition of the optically-transmissive metal oxide-adhering layer 114 may include reactive oxygen atoms bound to a metal M₃. The first and second bonding interfaces in the light-reflective article 100 may then respectively have a plurality of covalent (-M₁-oxygen-M₃-) bonds and a plurality of covalent (-M₃-oxygen-M₂-) bonds. For example, where each of M₁, M₂ and M₃ includes silicon, each of the first and second bonding interfaces may have a plurality of covalent (-silicon-oxygen-silicon-) bonds.

Silanols may, for example, have the formula R—Si—X₃, where R represents a carbon (—C—C—) or a siloxane (—Si—O—) chain and X represents a hydroxyl (—O—H) or alkoxy (—O—CₐH_{b}) moiety, a and b being integers. For example, such alkoxy moieties may include methoxy (—CH₃) or ethoxy (—C₂H₅) groups. Such alkoxy groups may be hydrolyzed to react with silicon-bound hydroxyl groups on the surface 115 of the optically-transmissive metal-adhering layer 106, forming (-silicon-oxygen-silicon-) bonds. The “R” chains may be selected as chemically compatible with, and suitable for reaction with carbon-bound moieties or silicon-bound moieties in, the curable, polymerizable composition corresponding to the organic moiety-containing polymer in the optically-transmissive protective layer 108. Examples of commercially-available compositions that may be utilized in forming the optically-transmissive metal oxide-adhering layer 114 include: KBC1003, KBE1003, KBM1003, KBM5103, KBM303, KBM403, KBE402, KBM603, KBM602, KBE903, KBM573, KBM803, and KBM703 silane coupling agents from Mitsubishi International Corp.; PrimerC from Dow Corning Corporation, P.O. Box 994, Midland, Mich. 48686-0994; NuSil primers from NuSil Technology LLC, 1050 Cindy Lane, Carpinteria, Calif. 93013 USA; SP-1 from Exxene Corporation, 5939 Holly Road, Corpus Christi, Tex. 78414; AP-Silane coupling agents from Advanced Polymer, Inc., 400 Paterson Plank Road Carlstadt, N.J. 07072; silicone primer grades SHP401 and SHP470 from Momentive Performance Materials, 22 Corporate Woods Boulevard, Albany, N.Y. 12211 USA; Chemlok primers from Lord Corporation, 111 Lord Drive, Cary, N.C. 27511-7923; and SiSiB silanes from Power Chemical Corporation Ltd., Jiangsu, China. In another example, the organic moiety-containing composition of the optically-transmissive metal oxide-adhering layer 114 may be selected as suitable so that the optically-transmissive metal oxide-adhering layer 114 may function as a protective layer of the light-reflective article 100 in addition to the optically-transmissive protective layer 108. In further examples, titanium-containing polymerizable compositions, having chemical structures analogous to the foregoing silicon-containing compositions, may also be utilized.

Further where a light-reflective article 100 includes an optically-transmissive metal oxide-adhering layer 114, the organic moiety-containing polymer in the optically-transmissive protective layer 108 may be selected as corresponding to a curable, polymerizable composition including carbon-bound moieties capable of reaction with metal-bound oxygen atoms or carbon-bound oxygen atoms or with other reactive moieties in the optically-transmissive metal oxide-adhering layer 114. The carbon-bound oxygen atoms may take the form of hydroxyl groups (—C—O—H), carbonyl groups (—C═O), or carboxylic acid groups ((—C═O)—O—H), as examples. The selected organic moiety-containing polymer in the optically-transmissive protective layer 108 may correspond to a curable, polymerizable composition having moieties including carbon and hydrogen, which may further contain one or more additional elements such as oxygen, metals and halogens. Metals so included in the organic moiety-containing polymer may as examples include those discussed in connection with the metal oxides for inclusion in the composition of the optically-transmissive metal-adhering layer 106. The optically-transmissive protective layer 108 may, for example, be formed on the optically-transmissive metal oxide-adhering layer 114 by causing such a curable, polymerizable composition to polymerize while reacting with metal-bound oxygen atoms or carbon-bound oxygen atoms or with other reactive moieties in the optically-transmissive metal oxide-adhering layer 114. In that example, the light-reflective article 100 may include a covalent bonding interface between the optically-transmissive protective layer 108 and the optically-transmissive metal oxide-adhering layer 114. The organic moiety-containing polymer in the optically-transmissive protective layer 108 may have a composition including a reactive moiety having a carbon atom C, wherein the composition of the optically-transmissive metal oxide-adhering layer 114 includes a metal or carbon atom E, and wherein the bonding interface has a plurality of covalent (—C-oxygen-E-) bonds. For example, where E includes carbon, the bonding interface may have a plurality of covalent (-carbon-oxygen-carbon-) bonds.

For example, the organic moiety-containing polymer in the optically-transmissive protective layer 108 may be selected as corresponding to a curable, polymerizable composition including a mono- or multi-functional acrylate monomer. Such an acrylate monomer may include a nucleophilic moiety selected from carboxylic acids, organophosphorus acids, organosulfur acids, nitrocellulose, or a mixture of two or more of the foregoing. The organic moiety-containing polymer in the optically-transmissive protective layer 108 may be correspond to a curable, polymerizable composition including such a nucleophilic moiety in chemically labile, unreacted form available for covalent bonding. In examples, the organic moiety-containing polymer in the optically-transmissive protective layer 108 may be selected as corresponding to a curable, polymerizable composition including a mono- or multi-functional acrylate monomer selected from acrylic acid esters, alkyl acrylic acid esters, aryl acrylic acid esters, acrylic acid alkyl esters, alkyl acrylic acid alkyl esters, aryl acrylic acid alkyl esters, and mixtures of two or more of the foregoing. Particular acrylate monomers that may be so utilized include, as examples, methyl acrylate, methyl methacrylate, ethyl acrylate, ethyl methacrylate, n-propyl acrylate, n-propyl methacrylate, n-isopropyl acrylate, n-isopropyl methacrylate, n-butyl acrylate, n-butyl methacrylate, isobutyl acrylate, isobutyl methacrylate, tert-butyl acrylate, tert-butyl methacrylate, 2-ethylhexyl acrylate, 2-ethylhexyl methacrylate, hydroxyethyl acrylate, hydroxyethyl methacrylate, hydroxypropyl acrylate, hydroxypropyl methacrylate, dimethylaminoethyl acrylate, dimethylaminoethyl methacrylate, phosphoethyl acrylate, phosphoethyl methacrylate, cyclohexyl methacrylate, neopentyl methacrylate, isobomyl methacrylate, 3,3,5-trimethylcyclohexyl methacrylate, stearyl methacrylate, and mixtures of two or more of the foregoing. Further, the organic moiety-containing polymer in the optically-transmissive protective layer 108 may include a copolymer of an acrylate monomer and another monomer. As examples, the organic moiety-containing polymer in the optically-transmissive protective layer 108 may include a mono- or multi-acrylate-functional polymer selected from epoxy acrylates, urethane acrylates, polyester acrylates, polyether acrylates, silicone acrylates, acrylic acrylates, cellulose acetate butyrates, fatty acid acrylates, poly(ethylene glycol) acrylates, and mixtures of two or more of the foregoing.

The organic moiety-containing polymer in the optically-transmissive protective layer 108 may further be selected as corresponding to a curable, polymerizable composition including a multi-functional acrylate monomer suitable for cross-linking. By “multifunctional” is meant that the acrylate monomer has two or more acrylate functional groups available for covalent bonding. As examples of such multi-functional acrylate monomers, pentaerythritol tetraacrylate, dipentaerythritol pentaacrylate, dipentaerythritol hexaacrylate, ethoxylated trimethylolpropane triacrylate, ethoxylated pentaerythritol triacrylate, propoxylated glyceryl triacrylate, trimethylolpropane triacrylate, pentaerythritol triacrylate, propoxylated trimethylolpropane triacrylate, trimethylolpropane trimethacrylate, tris(2-hydroxyethyl)isocyanurate triacrylate, and mixtures of two or more of the foregoing may be utilized.

In another example, the organic moiety-containing polymer in the optically-transmissive protective layer 108 may include a poly(acrylamide) corresponding to an acrylamide monomer. Such an acrylamide monomer may include a nucleophilic moiety selected from carboxylic acids, organophosphorus acids, organosulfur acids, nitrocellulose, and a mixture of two or more of the foregoing. The organic moiety-containing polymer in the optically-transmissive protective layer 108 may correspond to a curable, polymerizable composition including such a nucleophilic moiety in chemically labile, unreacted form available for covalent bonding. As examples, the acrylamide monomer may include N-methylol acrylamide, acrylamide, methacrylamide, N-tert-butylacrylamide, N-methylacrylamide, N,N-dimethyl acrylamide, or a mixture of two or more of the foregoing.

The organic moiety-containing polymer in the optically-transmissive protective layer 108 may also be selected as corresponding to a curable, polymerizable composition including a monomer selected from 1,3-butadiene, isoprene, acrylonitrile, methacrylonitrile, styrene, hydroxylated styrene, vinyl acetate, vinyl propionate, vinyl n-butyrate, vinyl laurate, vinyl stearate, divinylbenzene, 2-vinylnaphthalene, 9-vinylanthracene, methylstyrene, chlorostyrene, dimethylstyrene, 4-vinyl-biphenyl, vinyltoluene, triallyl cyanurate, dimethyl maleate, maleic acid n-butyl ester, dihydrodicyclopentadienyl acrylate, succinic acid, adipic acid, ethylene glycol, 1,4-butanediol, styrenesulfonic acid, diallyl ether, methane sulfonic acid, p-toluene sulfonic acid, vinylsulfonic acid, 2-acrylamido-2-methylpropanesulfonic acid, N-vinyl pyrrolidone, N-vinylformamide, N-vinylimidazole, gelatin, and mixtures of two or more of the foregoing.

Curable, polymerizable compositions for forming organo-siloxane silicone copolymers having a high resistance to abrasion that may be utilized in forming the optically-transmissive protective layer 108 are disclosed in the Harisiades et al., U.S. Pat. No. 5,426,204, entitled “Glass Coating With Improved Adhesion and Weather Resistance,” the entirety of which hereby is incorporated herein. Additional curable, polymerizable compositions that may be utilizing in forming the optically-transmissive protective layer 108 are disclosed in commonly-owned U.S. patent application Ser. No. 11/768,893, filed on Jun. 26, 2007, entitled “Light-Reflective Articles and Methods for Making Them,” the entirety of which hereby is incorporated herein.

The light-reflective metal layer 102 of the light-reflective article 100 may be on a supportive substrate 118. The supportive substrate 118 may, as examples, have a metal or polymeric composition. Where the supportive substrate 118 has a polymeric composition, that composition may include any polymer, polymer blend, or polymer-containing composite. The polymeric composition may include, as examples, an engineering polymer selected from thermoplastic polymers, thermosetting polymers, and mixtures. As additional examples, the polymeric composition may include a poly(olefin) such as polyethylene or polypropylene, or a poly(vinyl chloride), poly(styrene), poly(fluoroethylene), poly(acrylate), poly(vinyl acid ester), poly(carbonate), poly(ester), poly(urethane), poly(amide), poly(imide), poly(epoxide), poly(unsaturated ester), poly(acrylonitrile butadiene styrene), poly (styrene acrylonitrile), or a mixture of two or more of the foregoing. As an example of a poly(acrylate), poly(methylmethacrylate) may be utilized. As an example of a poly(carbonate), poly(butylmethylcarbonate) may be utilized. As an example of a poly(vinyl acid ester), poly(vinyl butyrate) or poly(vinyl acetate) may be utilized. The polymeric composition may include a filler for purposes of extending, strengthening, or otherwise changing the performance capabilities of the polymeric composition. Examples of fillers include wood, fiberglass, other fibrous materials such as poly(propylene) fibers, Kevlar® aramid fibers or carbon fibers, pigments, and mixtures of two or more of the foregoing. A poly(carbonate) designated as LS2-111 commercially available from General Electric Company, having a business address at 1 Plastics Avenue, Pittsfield, Mass. 01201 U.S.A., may be utilized. Another poly(carbonate) designated as Calibre 300EP-22 commercially available from Dow Chemical International, having a business address at 2030 Dow Center, Midland, Mich. 48674 U.S.A., may be utilized. Allyl diglycol carbonate, commercially available from PPG Industries, having a business address at One PPG Place, Pittsburgh, Pa. under the trade name CR-39®), may also be utilized. Further, a poly(methylmethacrylate) designated as CM205 commercially available from Chi Mei Corp., having a business address at 59-1 San Chia, Jen Te, Taiwan County, Taiwan R.O.C., may be utilized. The supportive substrate 118 may have any uniform or non-uniform physical thickness and may itself be an article or device, or a part of an article or device, on which the light-reflective metal layer 102 may be formed or attached. As another example, the light-reflective metal layer 102 may have a suitable physical thickness selected so that the light-reflective metal layer 102 may also serve as a supportive substrate for the light-reflective article 100. It will be noted that light does not need to be transmitted through the supportive substrate 118. Accordingly, the supportive substrate 118 may be, as examples, optically-transmissive, translucent, or opaque, and thus may be colored or uncolored.

The light-reflective article 100 may include a metal adhesion layer 120 between the light-reflective metal layer 102 and the supportive substrate 118. For example, the metal adhesion layer 120 may have a metal composition selected as capable of being attached to or formed as a layer strongly adhering to the supportive substrate 118 and as providing a surface 119 on which the light-reflective metal layer 102 may be strongly adhered. As examples, the metal adhesion layer 120 may have a composition including chromium, titanium, rhodium, or a combination including two or more of the foregoing. The metal adhesion layer 120 may for example have a composition including chromium, titanium, and/or rhodium, at a combined concentration of about 99 molar percent or more. Further, for example, a surface 121 of the supporting substrate 118 may be prepared for deposition of the metal adhesion layer 120 by providing an organosilicone tie-bond coating (not shown) on that surface 121. As an example, a composition including triethoxymethylsilane may be polymerized to form the organosilicone tie-bond coating.

In operation of the light-reflective article 100, light enters the surface 103 of the optically-transmissive protective layer 108, travels along a path for example in directions of arrows 109, is reflected by the surface 110 of the light-reflective metal layer 102, travels along a path for example in directions of arrows 112, and exits the light-reflective article 100 at the surface 103 of the light-transmissive protective layer 108. The light so reflected by the surface 110 may then be observed by a person X, positioned for viewing the surface 110 in the direction of an arrow 122 for example. In that operation of the light-reflective article 100, the light traveling along paths in the directions of the arrows 109, 112 and reflected by the surface 110 does not pass through the supportive substrate 118, the metal-adhesion layer 120, or the light-reflective metal layer 102.

Viewed from the vertical direction of the arrow 122, the light-reflective article 100 may have any selected shape and dimensions (e.g., round, circular, elliptical, rectilinear, polygonal, irregular, etc.). Moreover, with reference to a plane perpendicular to the direction of the arrow 122 and directed into and out from the drawing sheet of FIG. 1, the surface 110 of the light-reflective metal layer 102 may be planar and thus parallel with such a reference plane or alternatively may be contoured (e.g., concave, convex, or including both concave and convex regions) relative to the reference plane. Likewise, with reference to the plane perpendicular to the direction of the arrow 122, the external surface 103 of the optically-transmissive protective layer 108 may be flat and thus parallel with such a reference plane or alternatively may be contoured (e.g., concave or convex) relative to the reference plane. The orientation of the light-reflective article 100 as depicted in FIG. 1 is arbitrary and thus terms such as “upper,” “lower,” “vertical,” and “horizontal” are merely descriptive of the illustrated example and are not limiting.

The physical thicknesses of layers in the light-reflective articles discussed throughout the specification, including for example the light-reflective article 100, are defined in a direction parallel with the direction of the arrow 122. The physical thickness of a layer such as the optically-transmissive protective layer 108 of a light-reflective article 100 (as well as other layers) may not be precisely uniform over a given width or length of the light-reflective article 100 transverse to such a physical thickness. The term “physical thickness” as used herein accordingly is considered as an average physical thickness of a layer over a given such width or length.

The supportive substrate 118 may have any selected physical thickness. For example, the supportive substrate 118 may have a physical thickness sufficient to provide structural support to the light-reflective article 100. As an example, the supportive substrate 118 may have a physical thickness within a range of between about one millimeter (“mm”) and about one centimeter (“cm”). The metal-adhesion layer 120 may have any selected physical thickness. For example, the metal-adhesion layer 120 may have a physical thickness minimized so as to add minimal weight to the light-reflective article 100. As an example, the metal-adhesion layer 120 may have a physical thickness within a range of about 100 nm and about 2 nm, or of about 2 nm.

The light-reflective metal layer 102 may have a physical thickness sufficiently large to allow only negligible transmission of visible light through or to prevent transmission of visible light through the light-reflective metal layer 102. For example, the light-reflective metal layer 102 may have a physical thickness of at least about 100 nm. The light-reflective metal layer 102 may have any physical thickness greater than about 100 nm as may be selected, for example a physical thickness sufficient such that the light-reflective metal layer 102 may provide structural support to the light-reflective article 100.

The optically-transmissive metal layer 104 has a physical thickness sufficiently small to allow transmission of visible light through the optically-transmissive metal layer 104. In an example, the optically-transmissive metal layer 104 may have a physical thickness sufficiently small to allow transmission of solar light through the physical thickness of the optically-transmissive metal layer 104 without substantially reducing the intensity of the transmitted solar light, averaged over the visible light spectrum. It is understood throughout this specification that the term “substantially reducing the intensity of the transmitted solar light, averaged over the visible light spectrum” denotes a reduction of about 20% or more in the intensity of the so transmitted solar light, averaged over the visible light spectrum. For example, the optically-transmissive metal layer 104 may have a physical thickness within a range of between about 1 nm and about 30 nm. In another example, the optically-transmissive metal layer 104 may have a physical thickness of about 1.3 nm. Further, the physical thickness of the optically-transmissive metal layer 104 may be increased or decreased to accordingly increase or decrease absorbance of light by the optically-transmissive metal layer 104 as earlier discussed.

The optically-transmissive metal-adhering layer 106 has a physical thickness sufficiently small to allow transmission of visible light through the optically-transmissive metal-adhering layer 106 In an example, the optically-transmissive metal-adhering layer 106 may have a physical thickness sufficiently small to allow transmission of solar light through the physical thickness of the optically-transmissive metal-adhering layer 106 without substantially reducing the intensity of the transmitted solar light, averaged over the visible light spectrum. The metal oxide-containing composition of the optically-transmissive metal-adhering layer 106 may be highly transparent to visible light. For example, the optically-transmissive metal-adhering layer 106 may have a composition including silicon dioxide, or “glass”. The optically-transmissive metal-adhering layer 106 may, as examples, have a physical thickness within a range of between about 1 nm and about 200 nm, or within a range of between about 80 nm and about 120 nm. For example, an optically-transmissive metal-adhering layer 106 having a composition including silicon dioxide may have a physical thickness of about 120 nm. The composition and physical thickness of the optically-transmissive metal-adhering layer 106 may also be selected, for example, to adjust relative intensities of transmission of visible light of various wavelengths through the optically-transmissive metal-adhering layer 106.

The sensitivity of human eyesight to light perceived as green and having wavelengths within a range of between about 485 nm and about 585 nm generally is greater than the sensitivity of such eyesight to light perceived as blue at wavelengths within a range of between about 400 nm and about 485 nm or to light perceived as red at wavelengths within a range of between about 585 nm and about 750 nm. Accordingly, a light-reflective article 100 utilized as a rear-view automobile mirror may generate glare within the wavelength range of light perceived as green, if the light-reflective performance of the light-reflective article 100 is such that green light is reflected with comparable intensity as is light within the wavelength ranges of blue and red light. This green glare effect may be particularly pronounced at night-time when an automobile driver often contends with high-intensity light from other vehicles' headlights then being illuminated, that is reflected by such a light-reflective article 100.

Accordingly, for example, the physical thickness of the optically-transmissive metal-adhering layer 106 of a light-reflective article 100 intended for end-utilization as an automotive rear-view mirror, or as another light-reflective interior surface of an automobile, may be selected as corresponding to an optical thickness suitable for reducing intensity of light reflections within the perceived green wavelength range. As an example, the physical thickness of the optically-transmissive metal-adhering layer 106 may be selected as corresponding to a half-wave optical thickness for the composition of the optically-transmissive metal-adhering layer 106 at a selected reference light wavelength. For example, a reference light wavelength of about 550 nm, or another wavelength within the perceived green light wavelength range, may be utilized. The optical thickness of a given optically-transmissive metal-adhering layer 106 is equivalent to the product of the refractive index of the layer composition at the reference light wavelength, multiplied by the physical thickness of the optically-transmissive metal-adhering layer 106. An angle of incidence of the reference light onto the surface 110 of the light-reflective article 100 for these calculations may be set at zero degrees (0°), meaning that the light is collimated in the direction 122. Further, for example, a range of suitable physical thicknesses for the optically-transmissive metal-adhering layer 106 may be calculated using the same formula, such range of physical thicknesses corresponding to the half-wave optical thickness multiplied by a factor of between about 0.8 and about 1.2. Hence, a suitable physical thickness for the optically-transmissive metal-adhering layer 106 may be selected. An optical effect of selecting an optically-transmissive metal-adhering layer 106 having a physical thickness corresponding to such a half-wave optical thickness is that light passing through the optically-transmissive metal-adhering layer 106, for example in directions 109, 112, is attenuated for a range of wavelengths including the reference wavelength, 550 nm for example. Hence, the green glare effect may be reduced by utilizing an optically-transmissive metal-adhering layer 106 having such a selected physical thickness.

One or more of the other optically-transmissive layers of a light-reflective article 100 may, as further examples, have a physical thickness selected as a quarter-wave optical thickness calculated for the composition of such a layer at a reference wavelength such as 550 nm. Where such other optically-transmissive layers of a light-reflective article 100 have physical thicknesses corresponding to their quarter-wave optical thicknesses, transmission of light through such optically-transmissive layers in directions 109, 112 may be maximized for a range of wavelengths including the reference wavelength, such as 550 nm. Further, for example, a range of suitable physical thicknesses for the optically-transmissive layers may be calculated, such range of physical thicknesses corresponding to the quarter-wave optical thickness multiplied by a factor of between about 0.8 and about 1.2. This maximized light transmission through a layer having a physical thickness corresponding to its quarter-wave optical thickness may also be achieved where the physical thickness of the layer is calculated by the same formula, but using as the optical thickness, a sum of its quarter-wave optical thickness plus a multiple of its half-wave optical thickness. As examples, the optically-transmissive metal layer 104, the optically-transmissive metal oxide-adhering layer 114, and the optically-transmissive protective layer 108 may have optical thicknesses selected as such quarter-wave optical thicknesses or as including such multiples. Further background regarding the calculation of quarter-wave and half-wave optical thicknesses of layers of optically-transmissive compositions, and regarding selection of a half-wave optical thickness of a layer for inclusion in a light-reflective article having reduced green glare, is disclosed in Nakajima U.S. Pat. No. 4,805,989 issued on Feb. 21, 1989, entitled “Multi-Layered Back Reflecting Mirror,” the entirety of which is hereby incorporated herein by reference.

A light-reflective article 100 may include one or more pairs of mutually-adjacent layers having substantially equivalent refractive indices at a selected reference light wavelength. Throughout this specification, a first refractive index is “substantially equivalent” to a second refractive index if the second refractive index is no more than ten (10) % larger or smaller than the first refractive index. For example, a reference light wavelength of about 550 nm may be utilized. In such a light-reflective article 100, birefringence of light transmitted between such a pair of mutually-adjacent layers may be moderated. Birefringence is an optical phenomenon whereby light may be refracted in two different directions at an interface between two materials having different refractive indices. In an example, a light-reflective article 100 may include an optically-transmissive metal-adhering layer 106 and an optically-transmissive protective layer 108 having substantially equivalent refractive indices at a selected wavelength of visible light. Silicon dioxide, for example, has a relatively low refractive index of about 1.45 at 550 nm, which may be adjusted upward to about 1.48 at 550 nm by addition of a small concentration of another metal oxide having a relatively high refractive index, such as aluminum oxide. Such a mixed metal oxide composition may then be utilized in forming an optically-transmissive metal-adhering layer 106 having a refractive index substantially equivalent at a selected wavelength of visible light to that of a selected optically-transmissive protective layer 108. For example, compositions including a mixture of silicon dioxide and aluminum oxide having the trade designation “Lima” and commercially available from Umicore, having a business address at Broekstraat 31 rue du Marais, B-1000 Brussels Belgium (www.umicore.com), may be utilized. Further, for example, a light-reflective article 100 may include an optically-transmissive metal-adhering layer 106, an optically-transmissive metal oxide-adhering layer 114, and an optically-transmissive protective layer 108, wherein at least two of such layers 106, 114, 108 have substantially equivalent refractive indices at a selected wavelength of visible light. Likewise, a light-reflective article 100 may include one or more other pairs of mutually-adjacent layers among layers 102, 104, 106, 114, 108 having substantially equivalent refractive indices at a selected reference light wavelength.

The optically-transmissive metal oxide-adhering layer 114 may have a physical thickness sufficient for causing the optically-transmissive metal-adhering layer 106 and the optically-transmissive protective layer 108 to be securely adhered together. Further, the optically-transmissive metal-adhering layer 114 may have a minimized physical thickness so as to add minimal weight to the light-reflective article 100 and so as to have a minimal optical effect on light transmitted along directions of arrows 109, 112 through the light-reflective article 100. The optically-transmissive metal oxide-adhering layer 114 has a physical thickness sufficiently small to allow transmission of visible light through the optically-transmissive metal oxide-adhering layer 114. In an example, the optically-transmissive metal oxide-adhering layer 114 may have a physical thickness sufficiently small to allow transmission of solar light through the physical thickness of the optically-transmissive metal oxide-adhering layer 114 without substantially reducing the intensity of the transmitted solar light, averaged over the visible light spectrum. As an example, the optically-transmissive metal oxide-adhering layer 114 may have a physical thickness within a range of about 100 nm and about 2 nm.

The optically-transmissive protective layer 108 may have a physical thickness sufficiently large for protecting the light-reflective article 100 against physical damage by external forces, such as abrasion, scratching, impact of foreign objects, and intrusion of oxidizing and corrosive agents such as water and salt. The optically-transmissive protective layer 108 has a physical thickness sufficiently small to allow transmission of visible light through the optically-transmissive protective layer 108. The optically-transmissive protective layer 108 may have a physical thickness not too great for high transparency for a selected layer composition to light across the visible wavelength spectrum. In an example, the optically-transmissive protective layer 108 may have a physical thickness sufficiently small to allow transmission of solar light through the physical thickness of the optically-transmissive protective layer 108 without substantially reducing the intensity of the transmitted solar light, averaged over the visible light spectrum. For example, an optically-transmissive protective layer 108 may have a selected physical thickness for a given layer composition, being sufficient such that the optically-transmissive protective layer 108 may transmit in excess of 98% of light at a reference wavelength of about 550 nm.

The optically-transmissive protective layer 108 may form a wear-resistant protective surface 103 of the light-reflective article 100. In one example, the surface 103 of the optically-transmissive protective layer 108 may have a hardness of 5H or more as measured by a pencil hardness test according to ASTM D 3363-92a and ECCA T4 (1984), the entireties of which standards are incorporated by reference herein. In other examples, the surface 103 of the optically-transmissive protective layer 108 may have a hardness as high as 9H. Accordingly, in further examples, the optically-transmissive protective layer 108 may have a hardness of 6H, 7H, or 8H. The pencil hardness test may be performed, for example, by utilizing a Wolff-Wilborn pencil hardness tester available from Gardco (Paul N. Gardner Company, Inc., Pompano Beach, Fla.).

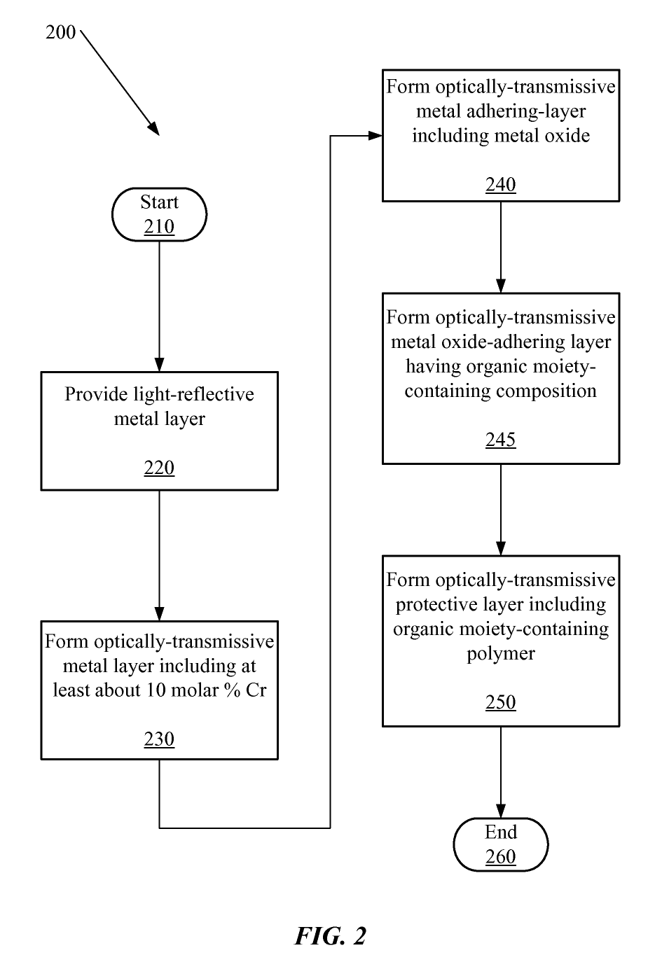

FIG. 2 is a flow diagram illustrating an example of a method 200. The method 200 may be utilized, for example, in fabricating a light-reflective article 100. The method starts at step 210, and then step 220 includes providing a light-reflective metal layer 102. At step 230, an optically-transmissive metal layer 104 is formed on the light-reflective metal layer 102, the optically-transmissive metal layer 104 having a composition including at least about ten (10) molar % of chromium. At step 240, an optically-transmissive metal-adhering layer 106 is formed on the optically-transmissive metal layer 104, the optically-transmissive metal-adhering layer 106 having a composition including a metal oxide. Step 250 includes forming an optically-transmissive protective layer 108 on the optically-transmissive metal-adhering layer 106, the optically-transmissive protective layer 108 having a composition including an organic moiety-containing polymer. The method 200 may then end at step 260.

In an example, forming the optically-transmissive metal-adhering layer 106 at step 240 may include utilizing a metal oxide including silicon. As another example, forming the optically-transmissive protective layer 108 at step 250 may include forming a silicone polymer. The method 200 may include, at step 245, forming an optically-transmissive metal oxide-adhering layer 114 between the optically-transmissive metal-adhering layer 106 and the optically-transmissive protective layer 108, the optically-transmissive metal oxide-adhering layer 114 having an organic moiety-containing composition. As an example, forming the optically-transmissive metal oxide-adhering layer 114 may include utilizing a composition including silicon.

The method 200 may further include forming or providing a supportive substrate 118. As an example, providing the light-reflective metal layer 102 in step 220 may include attaching or forming the light-reflective metal layer 102 on the supportive substrate 118. Further, for example, the method may include forming a metal-adhesion layer 120 on the supportive substrate 118 before attaching or forming the light-reflective metal layer 102. In fabricating a light-reflective article 100 including a supportive substrate 118, the supportive substrate 118 may be cleaned or otherwise surface-prepared prior to forming a metal-adhesion layer 120 or the light-reflective metal layer 102 on the supportive substrate 118.

In an example, physical thicknesses of the layers 104, 106 may be determined in part by optically monitoring the perceptual color of the partially-formed light-reflective article 100 during the layer deposition. For example, pulsed light having a selected reference wavelength such as 550 nm may be directed in the directions of arrows 109 toward the surface 110, and light reflected by the surface 110 in directions of arrows 112 may be monitored by a suitable spectrographic detector. The pulsed 550 nm light may be produced by passing a light beam through a beam chopper wheel and a narrow band-pass filter. Deposition of a layer 104, 106 may be terminated when a predetermined spectral profile of the reflected light is detected.

In examples, steps 220, 230 and 240 may be carried out under a continuous vacuum to prevent formation of metal oxides of the compositions utilized in forming the light-reflective metal layer 102 and the optically-transmissive metal layer 104 prior to completing step 240. Formation of metal oxides prior to carrying out step 240 might prevent the formation of strong interfacial bonds between the layers 102, 104, 106. For example, steps 220, 230, 240 may be carried out under a vacuum in the presence of an inert gas. Examples of suitable inert gases include helium, nitrogen, noble gases such as argon, krypton, neon, and zenon, and mixtures. As an alternative to carrying out steps 220, 230, 240 under a vacuum, a blanketed atmosphere of such inert gases may be utilized. The composition for the optically-transmissive protective layer 108 is selected as forming a strong interfacial bond with the metal oxide in the composition of the optically-transmissive metal-adhering layer 106 or with the organic moiety-containing composition of the optically-transmissive metal oxide-adhering layer 114. Likewise, the composition for the optically-transmissive metal-oxide-adhering layer 114 is selected as forming a strong interfacial bond with the metal oxide in the composition of the optically-transmissive metal-adhering layer 106. Accordingly, formation of the optically-transmissive metal oxide-adhering layer 114 at step 245 and of the optically-transmissive protective layer 108 at step 250 may generally be carried out in an ambient atmosphere.

It is understood that the method 200 may be utilized in fabricating a light-reflective article having any of the features of the examples of light-reflective articles 100 discussed in this specification. It is understood that the discussion herein of the light-reflective articles 100 illustrates suitable variations of the method 200. Likewise, it is understood that the discussion of the method 200 herein illustrates suitable variations of the light-reflecting articles 100. Accordingly, the entire discussion of the light-reflective articles 100 is deemed incorporated into the discussion of the method 200. In addition, the entire discussion of the method 200 is deemed incorporated into the discussion of the light-reflective articles 100.

One or more of steps 220, 230, 240, 245 and 250 of the method 200, as well as forming a metal-adhesion layer 120, may be carried out, for example, by vapor deposition. As examples, reagents for forming one or more of the layers 120, 102, 104, 106, 114 and 108 of a light-reflective article 100 may be evaporated in a vacuum and deposited, respectively, onto a supportive substrate 118 and onto the layers 120, 102, 104, 106, and 114. Other processes for depositing a vapor in one or more forms including atoms, ions and molecules in a vacuum environment may be utilized. In further examples, a magnetron sputtering process may be utilized for forming ions of compositions for forming one or more of the layers 120, 102, 104, and 106, and the ions may be deposited, respectively, onto a supportive substrate 118 and onto the layers 120, 102, and 104. For example, other sputtering processes may be utilized. As examples, reagents for forming either or both of the layers 114, 108 of a light-reflective article 100 may be dip-coated, flow-coated, spray-coated, spun-on, or curtain-coated respectively onto layers 106, 114. Solvents for the liquid compositions utilized in forming the optically-transmissive metal oxide-adhering layer 114 and the optically-transmissive protective layer 108 may be selected based on suitability for forming a smooth surface 103 of the light-reflective article 100. As an example, the coating technique utilized may be selected and managed to form an optically smooth surface 103. Vapor deposition, sputtering, dip-coating, flow-coating, and other coating techniques discussed herein are merely examples, and other suitable techniques for forming layers of light-reflective articles 100 may be utilized. The flow diagram 200 may also represent an apparatus or system configured to perform the illustrated method.

Suitable vacuum deposition techniques (including appropriate cleaning and or other preparation steps) may include, as examples, physical vapor deposition (PVD), chemical vapor deposition (CVD), thermal evaporation, and variants and hybrids of the foregoing. The deposition technique may also be a plasma-enhanced CVD (PECVD) technique in which a DC-, RF- or microwave-powered energetic plasma or corona discharge may be generated from a suitable inert background gas (e.g., helium, argon, krypton, neon, xenon, etc.), and/or by a focused ion beam, electron beam, or laser. The specific technique employed may depend on the selected compositions of the layers 102, 104, 106, 120. For example, the supportive substrate 118 or a partially-fabricated article 100 may be loaded in a vacuum deposition chamber along with a solid metal target. The metal target may be sputtered by a focused ion beam or an energetic plasma, or may be thermally evaporated or sublimated, and the metal may be transported to the supportive substrate 118 or other layer surface to be coated under the influence of a DC or AC, continuous or pulsed, voltage bias impressed between the metal target and a holder of the supportive substrate 118 or partially-formed article 100. In another example, the metal species may be provided by dissociating a metal-containing precursor gas (e.g., an organometallic compound) in an energetic plasma. A plasma-enhanced technique, when implemented, may be assisted through the operation of a magnetron and/or inductive coupling device. As examples, the temperatures of the supportive substrate 118 or partially-fabricated article 100 and of the chamber interior during layer deposition operations may vary according to the specific technique employed and composition of the component layers of the article 100, provided that the temperature may be limited so as to not be high enough to degrade (e.g., melt, denature, depolymerize, etc.) the partially-fabricated article 100.

In the fabrication of light-reflective articles 100, a single reaction chamber and associated system may be configured to perform all of the various steps of the method 200, which may as examples include vacuum deposition and surface treatment steps, required for fabricating the light-reflective articles 100. For instance, the same reaction chamber may include more than one type of target, more than one type of energetic source, more than one inlet or distribution hardware for different gases, and/or more than one distinct sub-chamber or deposition station. A holder for a supportive substrate 118 or partially-fabricated article 100 may be movable to different sub-chambers or deposition stations if such are provided. The same reaction chamber may be configured to generate wide-beam plasmas, narrow-beam plasmas, and/or ion beams or other energetic beams directed at or between different targets or sub-chambers and the partially-fabricated article 100. The associated deposition processing system may be configured for routing different background, precursor and reaction gases according to predetermined sequences, flow rates, flow ratios, etc. Generally, the reaction chamber and associated system may include devices for controlling various process parameters (e.g., electrical power, voltage bias, gas flow rates, supportive substrate temperature, chamber pressure, etc.) specific to the deposition or surface preparation of each layer being formed of the partially-fabricated article 100.

By such configurations for example, once a layer 120, 102, 104, 106 has been provided, the vapor deposition reaction chamber may be purged and evacuated for the next step. Surface preparations/modifications may then be carried out under an unbroken vacuum in the same reaction chamber. Examples of cleaning or surface preparation techniques include, but are not limited to, dry etching via ion beam bombardment, sputtering, or plasma exposure.

### EXAMPLES

Light-reflective articles 100 fabricated in accordance with the examples described above may be tested to determine whether such light-reflective articles 100 meet various performance standards required by the automotive industry for conventional light-reflective articles. Applicants believe that the light-reflective articles 100 will meet these performance standards, although none of the Examples included herein relating to testing of light-reflective articles have as yet been carried out. It is understood throughout this specification that the entireties of all testing-related and fabrication-related standards referred to anywhere in this specification are incorporated herein by reference. All compositions utilized in the light-reflective articles 100 discussed below may include appropriate material certifications such as lab accreditation or ISO certification, in accordance with Ford Motor Company's performance specification WSK-M4D775-A2, the entirety of which is incorporated herein by reference.

### Example 1

Light-reflective articles 100 fabricated in accordance with the examples described above and illustrated in FIGS. 1 and 2 may be subjected to temperature/humidity cycling and adhesion testing. Meeting the performance criteria (i.e., passing the test) requires that the optically-transmissive protective layer 108 not be damaged by prolonged exposure to a temperature/humidity cycling environment followed by an adhesion test. The sample light-reflective articles 100 are examined visually for any defects prior to the start of testing. The sample light-reflective articles 100 are then placed in a 3 ft×3 ft×3ft environmental chamber manufactured by Envirotronics, Grand Rapids, Mich. (Model No. SH27C). The environmental chamber is then repeatedly operated through a 48-hour controlled temperature and humidity cycle including 24 hours at 80° C. and ambient relative humidity; then 16 hours at 38° C. and 98% relative humidity; then 6 hours at −30° C. and ambient relative humidity; and then 2 hours at room temperature and ambient relative humidity. Each sample light-reflective article 100 is subjected to seven (7) of these 48-hour cycles, totaling 336 hours.

After the temperature/humidity cycling is completed, the sample light-reflective articles 100 are allowed to stabilize at room ambient temperature. At this time a visual inspection of the sample light-reflective articles 100 is made to determine whether any discoloration or visible loss of reflectivity of the sample light-reflective articles 100 has occurred compared with another sample light-reflective article 100 not subjected to the temperature and humidity cycling. Subsequently, an adhesion test is performed on each sample light-reflective article 100 by making a series of six (6) cuts into the sample light-reflective article 100 and then applying tape in a firmly secured manner over the cuts. The tape is then removed and a visual inspection is made to determine whether any of the coatings have been lifted from the respective sample light-reflective articles 100. This adhesion test is carried out in accordance with ASTM D-3359-02 “Standard Test Methods for Measuring Adhesion by Tape Test,” the entirety of which is incorporated by reference herein.

Passing this test protocol requires that no discoloration or visible loss of reflectivity is observed, nor any delamination or pinholes, as a result of the temperature/humidity cycling, and that the layers of the sample light-reflective articles 100 remain intact after the adhesion test. Applicants believe that light-reflective articles 100 will meet these performance standards, although this Example 1 has not yet been carried out.

### Example 2

Light-reflective articles 100 fabricated in accordance with the examples described above and illustrated in FIGS. 1 and 2 may be subjected to a paint oven repair test per Ford Motor Company's performance specification WSS-M98P13-A, Aug. 15, 1006, Section 3.4. Meeting the performance criteria (i.e., passing the test) requires that the light-reflective article 100 withstand a paint repair surface temperature of 115° C. for twenty (20) minutes with no deformation, functional damage, distortion, visual loss of reflectivity, or objectionable change in appearance of the reflective surface. The sample light-reflective articles 100 are placed in an environmental chamber manufactured by Envirotronics, Grand Rapids, Mich. (Model No. SHBC). The sample light-reflective articles 100 are exposed to the 115° C. environment in the environmental chamber for twenty (20) minutes. Meeting the performance criteria further requires that no abnormalities be noted, and that review of the tested light-reflective articles 100 compared to untested control sample light-reflective articles 100 finds no deformation, functional damage, distortion, visual loss of reflectivity, or objectionable change in appearance of the reflective surface. Applicants believe that light-reflective articles 100 will meet these performance standards, although this Example 2 has not yet been carried out.

### Example 3

Light-reflective articles 100 fabricated in accordance with the examples described above and illustrated in FIGS. 1 and 2 may be subjected to a heat aging test per Ford Motor Company's performance specification WSS-M98P13-A, Aug. 15, 1006, Section 3.5. Meeting the performance criteria (i.e., passing the test) requires that the light-reflective article 100 show no changes in appearance after heat aging when compared with the original, untested sample light-reflective article 100. Gaps, margins and surface waviness must be within original design tolerances after returning to ambient temperature. The sample light-reflective articles 100 are placed in an environmental chamber manufactured by Envirotronics, Grand Rapids, Mich. (Model No. SHBC). The sample light-reflective articles 100 are exposed to a temperature of 80° C.±2° C. in the environmental chamber for seven (7) days (168 hours) and then conditioned back to 23° C.±2° C. Meeting the performance criteria further requires that no abnormalities are noted when compared to the non-exposed control sample light-reflective articles 100; that the heat-exposed light-reflective articles 100 display no deformation, functional damage, distortion, visual loss of reflectivity, or objectionable change in appearance of the reflective surface; and that gaps, margins and surface waviness are within original design tolerances after returning to ambient temperature. Applicants believe that light-reflective articles 100 will meet these performance standards, although this Example 3 has not yet been carried out.

### Example 4

Light-reflective articles 100 fabricated in accordance with the examples described above and illustrated in FIGS. 1 and 2 may be subjected to an environmental test per Ford Motor Company's performance specification WSS-M98P13-A, Aug. 15, 1006, Section 3.6. Meeting the performance criteria (i.e., passing the test) requires that the light-reflective article 100 show no changes in appearance after environmental cycling when compared with the original, untested sample light-reflective article 100. Gaps, margins and surface waviness must be within original design tolerances after returning to ambient temperature. There should be no loss of adhesion between the layers of the light-reflective article 100. The sample light-reflective articles 100 are placed in an environmental chamber manufactured by Envirotronics, Grand Rapids, Mich. (Model No. SHBC). The sample light-reflective articles 100 are exposed to three (3) cycles for a total exposure of seventy-two (72) hours. Each cycle includes the following conditioning intervals within the environmental chamber: three hours at 80° C., followed by one hour at 23° C. and 50% relative humidity (RH), followed by three hours at −40° C., followed by one hour at 23° C. and 50% RH, and followed by sixteen (16) hours at 38° C. and 95% RH. The sample light-reflective articles 100 are then evaluated after conditioning back to 23° C.±2° C. Following conditioning, the sample light-reflective articles 100 are subjected to adhesion testing per Ford Laboratory Test Method (FLTM) BI 106-01 B, the entirety of which is incorporated by reference herein. Meeting the performance criteria further requires that no abnormalities are noted when compared to the non-exposed control samples; that the exposed light-reflective articles 100 display no deformation, functional damage, distortion, visual loss of reflectivity, or objectionable change in appearance of the reflective surface when compared to the untested sample light-reflective articles 100; and that following the adhesion test, the sample light-reflective articles 100 display no loss of adhesion among the layers of the light-reflective article 100. Applicants believe that light-reflective articles 100 will meet these performance standards, although this Example 4 has not yet been carried out.

### Example 5

Light-reflective articles 100 fabricated in accordance with the examples described above and illustrated in FIGS. 1 and 2 may be subjected to an accelerated resistance to exterior weathering test per Ford Motor Company's performance specification WSS-M98P13-A, Aug. 15, 1006, Section 3.7.2. The sample light-reflective articles 100 are subjected to a xenon arc weatherometer apparatus manufactured by Envirotronics, Grand Rapids, Mich. (Model No. P83-15), per SAE J1960 but modified (type “S” borosilicate inner and outer filters, 0.55 watts per square meter (W/m²) radiant exposure). The test calls for exposure for 3,000 hours (125 days). Meeting the performance criteria (i.e., passing the test) requires that the light-reflective article 100 show no color change in excess of the specified Gray Scale rating (AATCC Evaluation Procedure 1/ISO 105-A02, the entirety of which is incorporated by reference herein), and exhibit no cracking, crazing or other deterioration. Applicants believe that light-reflective articles 100 will meet these performance standards, although this Example 5 has not yet been carried out.

### Example 6

Light-reflective articles 100 fabricated in accordance with the examples described above and illustrated in FIGS. 1 and 2 may be subjected to a resistance to scratching test per Ford Motor Company's performance specification WSS-M98P13-A, Aug. 15, 1006, Section 3.7.3. Meeting the performance criteria (i.e., passing the test) requires that the light-reflective article 100 show a visual rating of no more than 2 at a 2-N force applied by a 1.0±0.1 millimeter steel ball. The sample light-reflective articles 100 are subjected to scratch testing per the procedure specified by protocol FLTM BN108-13, the entirety of which is incorporated by reference herein. This scratch test includes subjecting the sample light-reflective articles 100 to the protocol utilizing a mechanically-driven scratch unit manufactured by Gardner (Model No. AV1653). Meeting the performance criteria further requires that the sample light-reflective articles 100 display no damage to the reflective surface at the required 2-N force applied by the designated steel ball. Applicants believe that light-reflective articles 100 will meet these performance standards, although this Example 6 has not yet been carried out.

### Example 7

Light-reflective articles 100 fabricated in accordance with the examples described above and illustrated in FIGS. 1 and 2 may be subjected to a thermal shock test per Freightliner Standard 49-0085 (02/25/03 Section 7.2), which is a variation of Ford Motor Company's performance specification WSS-M80J6-A, Sep. 12, 1005, Section 3.7.3. Meeting the performance criteria (i.e., passing the test) requires that the light-reflective article 100 after thermal shock cycling shows no blistering or uneven appearance or other detrimental effects. The sample light-reflective articles 100 must not display distortion, and there must be no loss of adhesion, or cracking, or visual loss of reflectivity, or reduced distinctiveness of image (DOI) when compared to a master sample light-reflective article 100. There should also be no loss of adhesion among the layers of the light-reflective article 100. The sample light-reflective articles 100 are placed in a thermal shock chamber manufactured by Envirotronics, Grand Rapids, Mich. (Model No. SV3-2-2-10). The sample light-reflective articles 100 are exposed to thirty-six (36) cycles for a total exposure of six (6) consecutive days. Each 4-hour cycle includes the following conditioning intervals within the thermal shock chamber and a cold box, with transfers being made in one (1) minute or less: two hours at −40° C., followed by two hours at 78° C. Meeting the performance criteria further requires that no abnormalities be noted, and that the exposed light-reflective articles 100 display no loss of reflectivity or reduced distinctiveness of image (DOI) when compared to the master sample light-reflective article 100. Applicants believe that light-reflective articles 100 will meet these performance standards, although this Example 7 has not yet been carried out.

### Example 8

Light-reflective articles 100 fabricated in accordance with the examples described above and illustrated in FIGS. 1 and 2 may be subjected to a salt spray test per ASTM B117-03. Meeting the performance criteria (i.e., passing the test) requires the light-reflective article 100 after exposure to salt spray for 1,000 hours to display no discoloration, or visible areas of corrosion, or visible reduction in reflectivity; and to exhibit no loss of adhesion. The sample light-reflective articles 100 are placed in a salt spray chamber and exposed to a 5% salt solution at 95° F. for 1,008 hours (42 days). Meeting the performance criteria further requires that the exposed light-reflective articles 100 display no evidence of discoloration, loss of adhesion, visible areas of corrosion, or visible reduction in reflectivity. Applicants believe that light-reflective articles 100 will meet these performance standards, although this Example 8 has not yet been carried out.

### Example 9

Light-reflective articles 100 fabricated in accordance with the examples described above and illustrated in FIGS. 1 and 2 may be subjected to a solvent resistance test per FLTM BI 168-01. Meeting the performance criteria (i.e., passing the test) requires that the light-reflective article 100 after splashed with a given solvent for fifteen (15) minutes at 70° F. or 120° F. displays no change in physical appearance, and no marring or softening. The sample light-reflective articles 100 are cut into sections and each section has the cut edges taped with masking tape. The sample light-reflective articles 100 are then positioned at approximately a 15-degree angle from the vertical. One sample light-reflective article 100 per chemical is tested. A one milliliter (ml) pipette is employed to splash a given solvent on the top face of a given sample light-reflective article 100 and the solvent is allowed to run down the surface. After 15 minutes a visual examination is done, and any chemical left on the surface is removed using a clean cotton cloth. The surface is also checked for marring or softening. TABLE 5 below summarizes the tests to be performed.

TABLE 5

| | Method of | | |
|---|---|---|---|
| Chemicals | Exposure | Duration | Temperatures |
| Alcohols: | | | |
| Methanol (Reagent grade) | Splash | 15 min. | 70° F. |
| Isopropyl Alcohol | Splash | 15 min. | 70° F. |
| (Reagent grade) | | | |
| Esters: | | | |
| Ethyl acetate | Splash | 15 min. | 70° F. |
| (Denatured alcohol) | | | |
| Ketones: | | | |
| Acetone (Reagent grade) | Splash | 15 min. | 70° F. |
| Methylethylketone (MEK) | Splash | 15 min. | 70° F. |
| Reagent grade | | | |
| Hydrocarbons: | | | |
| Toluene (Reagent grade) | Splash | 15 min. | 70° F. |
| Xylene | Splash | 15 min. | 70° F. |
| Naphtha (Safety-Kleen | Splash | 15 min. | 70° F. |
| Premium solvent) | | | |
| Citrus Based Cleaners: | | | |
| D-Limonene | Splash | 15 min. | 70° F. |
| Ammonia: | | | |
| Windex | Splash | 15 min. | 70° F. |
| Acids: | | | |
| Sodium Hydroxide (pH 13) | Splash | 15 min. | 70° F. |
| Hydrofluoric Acid (pH < 1.0) | Splash | 15 min. | 70° F. |
| Sulfuric Acid (pH 2.5) | Splash | 15 min. | 70° F. |
| Sulfuric Acid (35% Battery acid) | Splash | 15 min. | 70° F. |

Applicants believe that light-reflective articles 100 will meet these performance standards as to all solvents applied, although this Example 9 has not yet been carried out.

### Example 10

Light-reflective articles 100 fabricated in accordance with the examples described above and illustrated in FIGS. 1 and 2 may be tested for reflectivity, transmittance, distortion, and radius of curvature, per Ford Motor Company's performance specification WSB-M26G8-E (including but not limited to sections 3.2, 3.5, 3.6.2, 3.7, 3.8.2 and 3.12), the entirety of which is incorporated herein by reference. All test values in this example are based on materials conditioned in a controlled atmosphere of 23° C.±2° C. and 50%±5% relative humidity for 24 hours. Meeting the performance criteria (i.e., passing the test) requires: that the coated surface of a sample light-reflective article 100 remains free from noticeable defects in accordance with section 3.5; that a sample light-reflective article 100 have a minimum reflectivity of 50% per SAE J964 section 3.6.2; that luminous transmittance (standard illuminant A, International Commission on Illumination (CIE)) of a sample light-reflective article 100 not exceed 4% measured at normal incident to the surface in accordance with section 3.7; that a sample light-reflective article 100 not exhibit any waviness as defined in section 3.8.2; and that the radius of curvature of a sample light-reflective article 100 remains within design specification tolerances as specified in section 3.12. Applicants believe that light-reflective articles 100 will meet these performance standards, although this Example 10 has not yet been carried out.

### Example 11

Light-reflective articles 100 fabricated in accordance with the examples described above and illustrated in FIGS. 1 and 2 may be subjected to an abrasion resistance test per Ford Motor Company's performance specification WSS-M80J6-A, Sep. 12, 1005, Section 3.7.1. Meeting the performance criteria (i.e., passing the test) requires that the optically-transmissive protective layer 108 after abrasion testing exhibit no more than a 7% increase in haze. The testing protocol calls for the sample light-reflective articles 100 to each be subjected to 300 abrasion cycles as defined in FLTM BN 108-02 using a Taber Abrader, a CS-10 wheel, and a 500 gram load. Meeting the performance criteria further requires that the exposed light-reflective articles 100 display less than a 7% increase in haze when compared to a master sample light-reflective article 100. Applicants believe that light-reflective articles 100 will meet these performance standards, although this Example 11 has not yet been carried out.

### Example 12

Light-reflective articles 100 fabricated in accordance with the examples described above and illustrated in FIGS. 1 and 2 may be subjected to adhesion testing in accordance with General Motors Engineering Standard GM4372M, June 1992, sections 3.4 and 3.5, the entirety of which is incorporated herein by reference. Meeting the performance criteria for adhesion (i.e., passing the adhesion test) requires that the sample light-reflective articles 100 be subjected to Saw Grind Test defined in ASTM B571, then subjected to 22 hours of CASS corrosion exposure as specified in ASTM B368, and then subjected to four thermal cycles, each cycle including: 1 hour at −30° C., 15 minutes at room temperature, 1 hour at 85° C., and then 15 minutes at room temperature. Meeting the performance criteria for adhesion (i.e., passing the adhesion test) requires that the light-reflective article 100 exhibit no evidence of lifting or peeling between layers of the sample light-reflective articles 100. Applicants believe that light-reflective articles 100 will meet these performance standards, although this Example 12 has not yet been carried out.

### Example 13

Light-reflective articles 100 fabricated in accordance with the examples described above and illustrated in FIGS. 1 and 2 may be subjected to grind saw, thermal shock, chip resistance, thermal cycle, and environmental cycle testing in accordance with Ford Engineering Standard WSB-M1P83-C2, the entirety of which is incorporated herein by reference. Meeting the performance criteria (i.e., passing the tests) requires that the sample light-reflective articles 100 be subjected to the following protocols, the entireties of all of which are incorporated herein by reference: Saw Grind Test defined in ASTM B571; then subjected to Thermal Shock FLTM BI107-05; then subjected to Chip Resistance SAE J400; then subjected to five thermal cycles, each cycle including: 2 hours at 80° C., 1 hour at room temperature, 2 hours at −30° C., 1 hour at room temperature, and 16 hours of CASS corrosion exposure as specified in ASTM B368; and then three environmental cycles, each cycle including: 3 hours at 80° C., 1 hour at room temperature, 3 hours at −40° C., 1 hour at room temperature. Meeting the performance criteria requires that the light-reflective article 100 exhibit no evidence of lifting or peeling between layers of the sample light-reflective articles 100. Applicants believe that light-reflective articles 100 will meet these performance standards, although this Example 13 has not yet been carried out.

### Example 14

Light-reflective articles 100 fabricated in accordance with the examples described above and illustrated in FIGS. 1 and 2 may be subjected to testing in accordance with Nissan Engineering Standard NES M4063, the entirety of which is incorporated herein by reference. Meeting the performance criteria (i.e., passing the test) requires that the sample light-reflective articles 100 be subjected to 80 hours of CASS corrosion exposure as specified in ASTM B368, and then subjected to four thermal cycles, each cycle including: 4 hours at 80° C., 30 minutes at room temperature, 1.5 hours at −40° C., 30 minutes at room temperature, 3 hours at 70° C. and 95% relative humidity, 30 minutes at room temperature, and 1.5 hours at −40 C. Meeting the performance criteria requires that the light-reflective article 100 exhibit no evidence of lifting or peeling between layers of the sample light-reflective articles 100. Applicants believe that light-reflective articles 100 will meet these performance standards, although this Example 14 has not yet been carried out.

### Example 15

Light-reflective articles 100 fabricated in accordance with the examples described above and illustrated in FIGS. 1 and 2 may be subjected to adhesion testing in accordance with Toyota Engineering Standard TSH 6504G, the entirety of which is incorporated herein by reference. Meeting the performance criteria requires that the sample light-reflective articles 100 be subjected to 60 hours of CASS corrosion exposure as specified in ASTM B368; then be subjected to Chip Resistance Test TSH1553G, and then subjected to four thermal cycles, each cycle including: 1 hour at −30° C., 15 minutes at room temperature, 1 hour at 90° C., and then 15 minutes at room temperature. Meeting the performance criteria requires that the light-reflective article 100 exhibit no evidence of lifting or peeling between layers of the sample light-reflective articles 100. Applicants believe that light-reflective articles 100 will meet these performance standards, although this Example 15 has not yet been carried out.

### Example 16

Light-reflective articles 100 fabricated in accordance with the examples described above and illustrated in FIGS. 1 and 2 may be subjected to adhesion testing in accordance with DCX Engineering Standard PS-8810, the entirety of which is incorporated herein by reference. Meeting the performance criteria requires that the sample light-reflective articles 100 be subjected to Saw Grind Test defined in ASTM B571, then subjected to three thermal cycles, each cycle including: 1 hour at 82° C., 1 hour at room temperature, 1 hour at −35° C., 1 hour at room temperature, and then 22 hours of CASS corrosion exposure as specified in ASTM B368. Meeting the performance criteria requires that the light-reflective article 100 exhibit no evidence of lifting or peeling between layers of the sample light-reflective articles 100. Applicants believe that light-reflective articles 100 will meet these performance standards, although this Example 16 has not yet been carried out.

### Example 17

Light-reflective articles 100 fabricated in accordance with the examples described above and illustrated in FIGS. 1 and 2 may be subjected to humidity and temperature resistance tests in accordance with General Motors Engineering Standard GM6119M, section 4, which references General Motors Engineering Standards GM4465P and GM9505P, the entireties of all of which are incorporated herein by reference. Meeting the performance criteria as to both of the humidity and temperature resistance tests requires that the sample light-reflective articles 100 show no evidence of objectionable surface deterioration or color change following the designated exposures, including as examples, blooming, blistering, spotting, stress crackings, corrosion, loss of adhesion, or objectionable dimensional changes. The humidity test is carried out in accordance with GM4465P at a temperature of 38° C.±1° C. for 24 hours. The temperature resistance test is carried out in accordance with GM9505P, utilizing two iterations of cycle D in Table 4, each beginning with carrying out the humidity test, and then exposing the sample light-reflective articles 100 to: 4 hours at 85° C.±2° C., then 3 hours at room temperature, then 17 hours ±2° C., then 168 hours at 70° C.±2° C., then 4 hours at −30° C.±70° C.±2° C. Applicants believe that light-reflective articles 100 will meet these performance standards, although this Example 17 has not yet been carried out.

The light-reflective articles 100 may be utilized in a wide variety of applications. Such applications may include as examples, but are not limited to, mirrors for either indoor or outdoor use; mirrors utilized for automobiles, motorcycles, trucks, bicycles, other land vehicles, boats, ships, and aircraft; mirrors utilized as or forming a part of tools or instruments; optical products such as windshields, windows, and lenses for vision-corrective glasses, sunglasses, or scientific instruments; articles, decorations, ornamentations, outer plating or coatings for which a reflective, shiny or chrome-like appearance may be useful, such as automotive grills, instrument panels and bezels, insignia, interior trim, accent panels of portable devices including personal digital assistants, jewelry, apparel, accessories adorning apparel, architectural detailing, sales displays, and the like. The light-reflective articles 100 may include complex shapes, detailing, light-reflective article surfaces conforming to surfaces of other articles, and other structural features taking advantage of the capability of forming the light-reflective articles 100 to have a wide variety of dimensions, contours, and other selected structural specifications. The method 200 may be utilized in fabricating a light-reflective article 100. While the foregoing description refers in some instances to the light-reflective articles 100, it is appreciated that the subject matter is not limited to these articles, or to the articles discussed in the specification. Articles having other configurations consistent with the foregoing teachings may be fabricated. Likewise, the method 200 may be utilized to fabricate any article including the stated layers, of which the light-reflective articles 100 are examples. Further, it is understood by those skilled in the art that the method 200 may include additional steps and modifications of the indicated steps.

The entirety of U.S. patent application Ser. No. 12/102,959, titled “Light-Reflective Articles and Methods for Making Same,” filed Apr. 15, 2008, assigned to the assignee of the present disclosure, is incorporated by reference herein.

It will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. An article, comprising:
a light-reflective metal layer;
an optically-transmissive metal layer on the light-reflective metal layer, the optically-transmissive metal layer having a composition including at least about ten molar % of chromium;
an optically-transmissive metal-adhering layer on the optically-transmissive metal layer, the optically-transmissive metal-adhering layer having a composition including a metal oxide; and
an optically-transmissive protective layer on the optically-transmissive metal-adhering layer, the optically-transmissive protective layer having a composition including an organic moiety-containing polymer.

2. The article of claim 1, wherein the optically-transmissive metal layer has a composition including at least about fifty molar percent of chromium.

3. The article of claim 2, wherein the optically-transmissive metal layer has a composition including at least about ninety-nine molar percent of chromium.

4. The article of claim 1, wherein the optically-transmissive metal-adhering layer and the optically-transmissive protective layer have substantially equivalent refractive indices at a selected wavelength of visible light.

5. The article of claim 1, wherein the light-reflective metal layer has an average optical reflectance of light across the visible light spectrum of at least about 80%.

6. The article of claim 1, wherein the optically-transmissive protective layer forms a wear-resistant protective surface of the article.

7. The article of claim 1, wherein the organic moiety-containing polymer in the optically-transmissive protective layer includes silicon.

8. The article of claim 7, wherein the organic moiety-containing polymer in the optically-transmissive protective layer includes a silicone.

9. The article of claim 1, wherein a metal oxide in the composition of the optically-transmissive metal-adhering layer includes silicon.

10. The article of claim 9, wherein the composition of the optically-transmissive metal-adhering layer includes one or a plurality of silicon oxides at a combined concentration of at least about 99 molar percent of the composition.

11. The article of claim 1, including a covalent bonding interface between the optically-transmissive protective layer and the optically-transmissive metal-adhering layer.

12. The article of claim 11, wherein the organic moiety-containing polymer in the optically-transmissive protective layer has a composition including a metal M₁, wherein a metal oxide in the composition of the optically-transmissive metal-adhering layer includes a metal M₂, and wherein the bonding interface has a plurality of covalent M₁-oxygen-M₂ bonds.

13. The article of claim 12, wherein M₁ is silicon, wherein M₂ is silicon, and wherein the bonding interface has a plurality of covalent silicon-oxygen-silicon bonds.

14. The article of claim 1, including an optically-transmissive metal oxide-adhering layer between the optically-transmissive metal-adhering layer and the optically-transmissive protective layer, the optically-transmissive metal oxide-adhering layer having an organic moiety-containing composition.

15. The article of claim 14, wherein the optically-transmissive metal-adhering layer and the optically-transmissive metal oxide-adhering layer have substantially equivalent refractive indices at a selected wavelength of visible light.

16. The article of claim 14, wherein the organic moiety-containing composition of the optically-transmissive metal oxide-adhering layer includes silicon.

17. The article of claim 14, including a covalent bonding interface between the optically-transmissive metal-adhering layer and the optically-transmissive metal oxide-adhering layer.

18. The article of claim 17, wherein the organic moiety-containing composition of the optically-transmissive metal oxide-adhering layer includes a metal M₃, wherein a metal oxide in the composition of the optically-transmissive metal-adhering layer includes a metal M₂, and wherein the bonding interface has a plurality of covalent M₃-oxygen-M₂ bonds.

19. The article of claim 18, wherein M₃ is silicon, wherein M₂ is silicon, and wherein the bonding interface has a plurality of covalent silicon-oxygen-silicon bonds.

20. A method, comprising:
providing a light-reflective metal layer;
forming an optically-transmissive metal layer on the light-reflective metal layer, the optically-transmissive metal layer having a composition including at least about ten molar % of chromium;
forming an optically-transmissive metal-adhering layer on the optically-transmissive metal layer, the optically-transmissive metal-adhering layer having a composition including a metal oxide; and
forming an optically-transmissive protective layer on the optically-transmissive metal-adhering layer, the optically-transmissive protective layer having a composition including an organic moiety-containing polymer.

21. The method of claim 20, wherein forming the optically-transmissive metal layer includes utilizing a composition including at least about fifty molar % of chromium.

22. The method of claim 20, wherein providing the light-reflective metal layer includes selecting a composition of the light-reflective metal layer having an average optical reflectance of light across the visible light spectrum of at least about 80%.

23. The method of claim 20, wherein forming the optically-transmissive protective layer includes forming a silicone.

24. The method of claim 20, wherein forming the optically-transmissive metal-adhering layer includes utilizing a metal oxide including silicon.

25. The method of claim 20, including forming an optically-transmissive metal oxide-adhering layer between the optically-transmissive metal-adhering layer and the optically-transmissive protective layer, the optically-transmissive metal oxide-adhering layer having an organic moiety-containing composition.

26. The method of claim 25, wherein forming the optically-transmissive metal oxide-adhering layer includes utilizing a composition including silicon.
